(19) United States
(12) Patent Application Publication
(10) Pub. No.: US 2019/0013672 A1
(43) Pub. Date: Jan. 10, 2019

(54) CONTROLLABLE DISTRIBUTED ENERGY APPLIANCES AND DEVICES

(71) Applicant: Wellhead Power Solutions, LLC, Sacramento, CA (US)

(72) Inventors: J. Grant McDaniel, Sacramento, CA (US); Christian Heiberger, Sacramento, CA (US); Ryan Daugherty, New York, NY (US)

(21) Appl. No.: 15/722,230

(22) Filed: Oct. 2, 2017

Related U.S. Application Data
(60) Provisional application No. 62/530,354, filed on Jul. 10, 2017.

(51) Int. Cl. H02J 3/32; G05F 1/66; H02J 13/00; H02J 3/38; H02J 7/00; H04L 12/28

(52) U.S. Cl. CPC H02J 3/32; G05F 1/66; H02J 13/0006; H02J 2003/143; H02J 7/0068; H04L 12/2803; H02J 3/386

(57) ABSTRACT

Various embodiments provide appliances and electronic devices and methods implemented in such appliances and electronic devices to improve Demand Response (DR) capabilities and responses while mitigating interrupts to services provided to consumers. Various embodiments improve on DR systems by equipping a variety of electronic devices and appliances with integrated internal energy storage (e.g., battery), control and communication capabilities that enable responding to DR events by splitting power drawn by the devices or appliances between the grid and the integrated internal energy storage. Some embodiments further improve on conventional DR systems by enabling utilities to recharge batteries in electronic devices and appliances when power on the grid exceeds demand, thereby enabling utilities to increase demand when required in order to better balance power demands with power generation. Such may support the grid by increasing or decreasing load on the grid in response to grid frequency.

### RELATED APPLICATIONS

This application claims the benefit of priority to U.S. Provisional Application No. 62/530,354 entitled “CONTROLLABLE DISTRIBUTED ENERGY APPLIANCES AND DEVICES” filed Jul. 10, 2017, the entire contents of which are hereby incorporated by reference.

### BACKGROUND

Demand Response (DR) is a mechanism by which electric utilities can turn off power to residences and businesses in order to manage peak loads on the electricity grid. While DR has enabled some utilities to manage grid loads during peak demands, the impact on a given residence or business can be significant. Typically, DR systems cut off all power to specific devices in a residence or business. Residences and businesses can take some actions to deal with the disruptions caused by DR events, such as installing battery backup power on some appliances, such as computers. Also, current DR systems provide no capability for responding to periods of excess power on the grid, as can occur in utilities that have significant wind and solar generating capacity.

### SUMMARY

Various embodiments include appliances and circuitry for use in appliances configured to respond to demand response events by using battery power to maintain use of the appliance. In some embodiments, the appliances and circuitry may be configured to respond to demand response events by splitting the power drawn by the appliance between a power grid and the battery.

Some embodiments may include methods for controlling energy usage of an appliance with an integral internal energy store by a processor within a control device that may include receiving a demand response signal from a utility, and in response to receiving the demand response signal controlling the appliance to reduce power drawn from the electrical grid, and providing power to the appliance from an integrated internal energy store such that the appliance is partially powered by the electrical grid and partially powered by the integrated internal energy store. In some embodiments, providing power to the appliance from an integrated internal energy store may involve splitting power supplied to the appliance between the grid and an energy store such that the appliance is partially powered by the electrical grid and partially powered by the integrated internal energy store.

Some embodiments may further include receiving electricity rate information from the utility, determining whether electricity rates are favorable, and in response to determining that electricity rates are favorable connecting the appliance to the grid if not already connected, and drawing power from the grid to recharge the integrated internal energy store. Some embodiments may further include determining a system frequency, and increasing or decreasing energy consumption in response to determining the system frequency is outside of an acceptable range. Some embodiments may further include measuring an amount of grid-supplied power consumed by the appliance and the control device, and sending the measured amount of power consumption to the utility.

Some embodiments may further include calculating a state of charge of the energy store, and sending the calculated state of charge to another computing device. In such embodiments, calculating a state of charge of the energy store may include calculating the state of charge of the energy store based on total power drawn from the energy store since the energy store last had a full state of charge, wherein the total power drawn is an integral of power output over time. Some embodiments may further include configuring the processor in response to a user input to adjust an amount of power drawn from the electrical grid and an amount of power drawn from the integrated internal energy store.

Various embodiments may include appliances or other devices that may include an energy store, a rectifier coupled to the energy store and configured to be connected to an electrical grid, an inverter coupled to the energy store and configured to be connected to an appliance, and a processor configured to control connections of the rectifier to the grid and connections of the inverter to the energy store and configured to perform operations of any of the methods summarized above. Various embodiments may include appliances or other devices that may include an energy store and means for performing functions of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a block diagram of a collection of light fixtures with varying functionalities according to various embodiments.

FIG. 2A is a block diagram of an A/C unit connected to power according to various embodiments.

FIG. 2B is a block diagram of an A/C unit connected to power via a Demand Response (DR) control device according to various embodiments.

FIG. 2C is a block diagram of an A/C unit connected to power via a DR control device according to various embodiments.

FIG. 2D is a block diagram of a DR control device connected to an AC appliance according to various embodiments.

FIG. 2E is a schematic of an DC power split controller.

FIG. 2F is a block diagram of a DR control device connected to a DC appliance according to various embodiments.

FIG. 2G is a schematic of an DC power split controller.

FIG. 2H is a block diagram of a battery current and state-of-charge controller circuit according to various embodiments.

FIG. 3 is a block diagram of a system for providing a DR without an interruption of service according to various embodiments.

FIG. 4 is a process flow diagram of a method for providing a DR without an interruption of service according to various embodiments.

FIG. 5 is a process flow diagram of a method for providing a DR without an interruption of service according to various embodiments.

FIG. 6 is a process flow diagram of a method for controlling grid resiliency aspects of a DR according to various embodiments.

FIG. 7 is a process flow diagram of a method for managing power measurement aspects of a DR according to various embodiments.

FIG. 8 is a process flow diagram of a method for managing the State of Charge (SOC) aspects of a storage in a DR component according to various embodiments.

FIG. 9 is graph illustrating a plot of grid and battery power (Watts) applied to a DC appliance based on a simulation of load splitting for a period of time according to various embodiments.

FIG. 10 is graph illustrating a plot of grid and battery power in Watts applied to an AC appliance based on a simulation of load splitting for a period of time according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide appliances and electronic devices and methods implemented in such appliances and electronic devices to improve Demand Response (DR) capabilities and responses while mitigating interrupts to services provided to consumers. Demand Response or “DR” refers to systems and agreement by which utilities can reduce the demand on the electricity grid by shutting off power to select devices in residences and businesses. “DR event” refers to an instance when a utility utilizes DR mechanisms to control power demands by residences and/or businesses. Conventionally, when power demand approached or exceeded the power generating capacity of the grid, a utility would send a signal to a DR component within residences and businesses to locally shut off the main power connection to the specific device. Various embodiments improve on DR systems by equipping a variety of electronic devices and appliances with energy storage (e.g., battery), control and communication capabilities that enable load splitting between the grid and the energy store, providing consumers with more options for deciding how DR events will be implemented at the level of individual appliances while meeting power reduction goals of the utility initiating a DR event. Some embodiments further improve on conventional DR systems by enabling utilities to recharge batteries in electronic devices and appliances when power on the grid exceeds demand, thereby enabling utilities to increase demand when required in order to better balance power demands with power generation.

Various embodiments include systems, devices and methods that enable an appliance or device to reduce power consumption from the grid while continuing to provide service to a consumer in response to a DR event. In various embodiments, a DR controller device may include an energy storage unit (e.g., a battery), a communication module, and a controller coupled to the communication module and configured to control the energy storage unit. In some embodiments, the DR controller device is implemented within an appliance (e.g., light bulbs, refrigerators, air-conditioners, etc.), while in some embodiments, the DR controller device may be a standalone battery backup system to which a variety of appliances may be connected. In various embodiments, energy from the electrical grid may be stored in the energy store during periods of non-peak demand. During periods of peak demand, the controller may control the flow of energy such that energy drawn from the electrical grid is reduced or eliminated while energy is drawn from the energy store. In this way, power consumption from the electrical grid may be reduced while still providing uninterrupted service to the consumer.

Various embodiments include systems and appliances that enable splitting the power supplied to an appliance between the grid and an internal battery, thereby enabling the load on the grid (and thus the amount of power purchased from the grid) to be reduced for a longer period of time and/or using a smaller battery than possible if the appliance were powered solely by the battery during periods of demand response events or expensive power. The various embodiments thus may enable consumers to program individual appliances or devices to individually respond to DR events by shutting off completely, running on battery power, or reducing grid power demands by supplementing power drawn from the grid with power drawn from the battery. Such programming may be accomplished directly via interfaces on the appliances or devices, or via a home or business communication network.

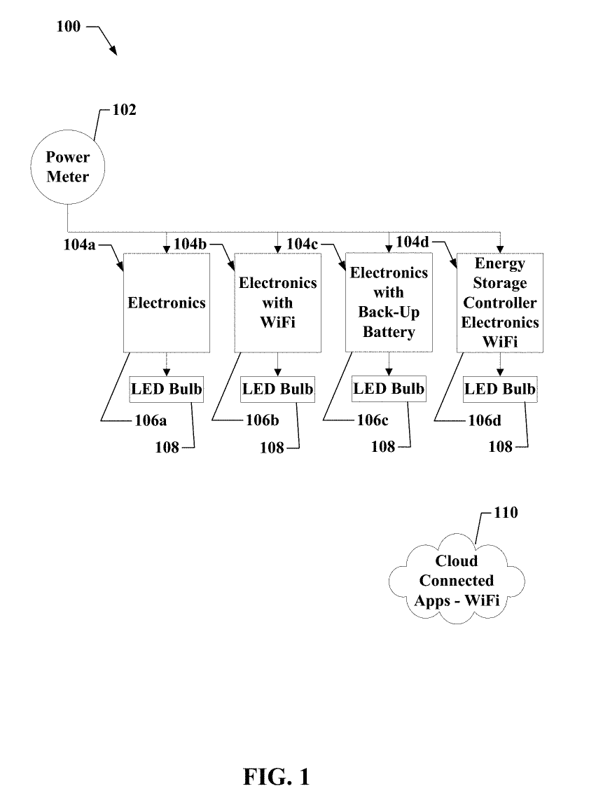

FIG. 1 is a system diagram of an example system of appliances, specifically a collection of light fixtures 104a-d, configured to respond to DR events according to various embodiments. Electronic capabilities implemented within appliances, such as light fixtures 104d-d, enable configurable responses to DR events. Control of appliances, such as light fixtures 104d-d, may be via control signals communicated by Wi-Fi via a local wireless network 122. The local wireless network 122 may be any of a variety of home or business communication networks, including Internet of things (IOT) networks, utility interface systems (e.g., the Efree™ platform offered by Wellhead Power Solutions), smart home/smart business systems (e.g., Google's Nest, Amazon's Echo), home/business WiFi networks, etc. In some embodiments, the local wireless network 122 may interface with a control hub 120 (e.g., the Efree™ platform offered by Wellhead Power Solutions) that is connected to the cloud 110 and configured to receive DR event communications from a utility 124. In some embodiments, the messages from the utility 124, as well as configuration messages from applications executing on user's computing devices 130, 132, may be received by the local wireless network 122 directly from the cloud 110. In such embodiments, a router or network controller (e.g., Google's Nest, Amazon's Echo) may function as the control hub 120 4 interfacing between a utility 124 and individual appliances such as light fixtures 104d-d.

In various embodiments, cloud connected apps 110 may provide consumers using an application running on computing devices, such as a smartphone 130, tablet, laptop 132, desktop, or other computing device, with an ability to remotely configure the DR response of the various appliances, such as light fixtures 104b-d, by connecting via the cloud 110 to the control hub 120 and/or local wireless communication network 122. The applications running on the user's computing devices 130, 132 may provide a user interface for assisting users in configuring individual appliances for responding to DR events, as well as providing status information, such as whether they are on or off and battery state of charge information.

In particular, computing devices may be configured with an app that presents a user interface that enables consumers to adjust the split between grid power and battery power when responding to DR events. For example, the user interface may include a dial or slide bar that the consumer can manipulate to adjust how much power is supplied by the battery, and thus the amount of power drawn from the grid. This user interface may also indicate (e.g., graphically as the dial or slide bar is moved) how long a given appliance can operate under each setting based upon a charge state of the battery and the current draw of the appliance. The user interface may enable the consumer to decide how the appliance should respond when the battery is exhausted (e.g., return to 100% grid power or turn off). The user interface may also enable the consumer to control settings for when the appliance battery should be recharged, when power splitting should occur based upon dynamic utility rates ($/KWHr), etc.

Appliances connected to such a network may include a variety of electronic capabilities. For example, the light fixture 104a may include electronics 106a and an LED bulb 108. The electronics 106a may enable the light fixture 104a to control the LED bulb 108 to provide illumination within a space or area. The light fixture 104b may include electronics with WiFi 106b and an LED bulb 108. The electronics with WiFi 106b may enable the light fixture 104b to be controlled remotely by WiFi via the local wireless communication network 122 while controlling the LED bulb 108 to provide illumination within a space or area. The light fixture 104c may include electronics with back-up battery 106c and an LED bulb 108. The electronics with back-up battery and WiFi 106c may enable the light fixture 104c to provide illumination within a space or area even if power from an electrical grid is interrupted. The light fixture 104d may include an energy storage controller, electronics, and WiFi 106d and an LED bulb 108. The energy storage controller, electronics, and WiFi 106d may enable the light fixture 104d to manage the flow of power from an electrical grid in order to respond to a DR event or other events without interruption of service (i.e., continuing to shine light).

The various light fixtures 104a-d may be connected to a power meter 102. In various embodiments, power meter 102 provides an interconnection with an electrical grid and delivers power from the electrical grid to the light fixtures.

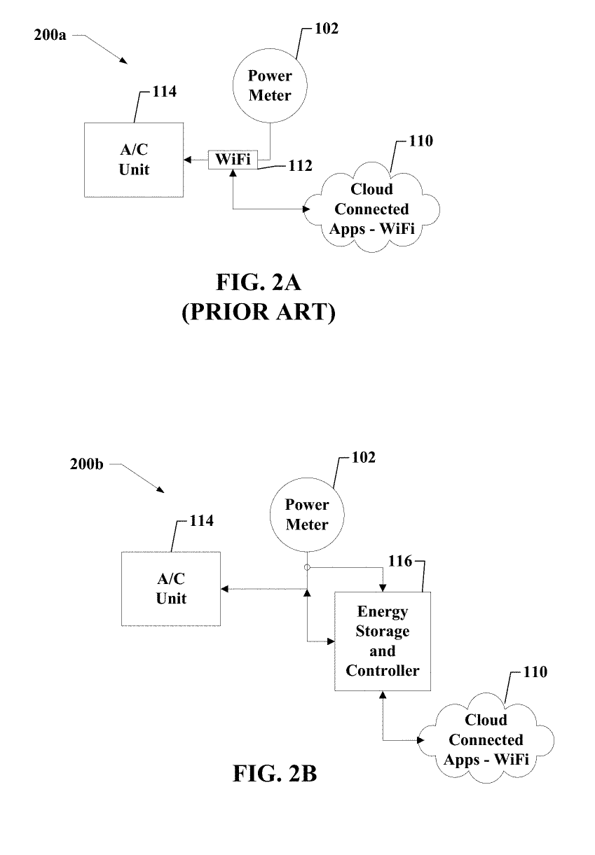

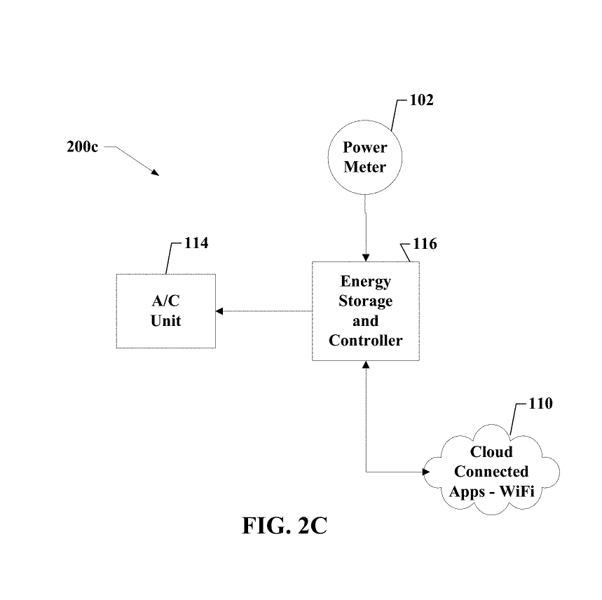

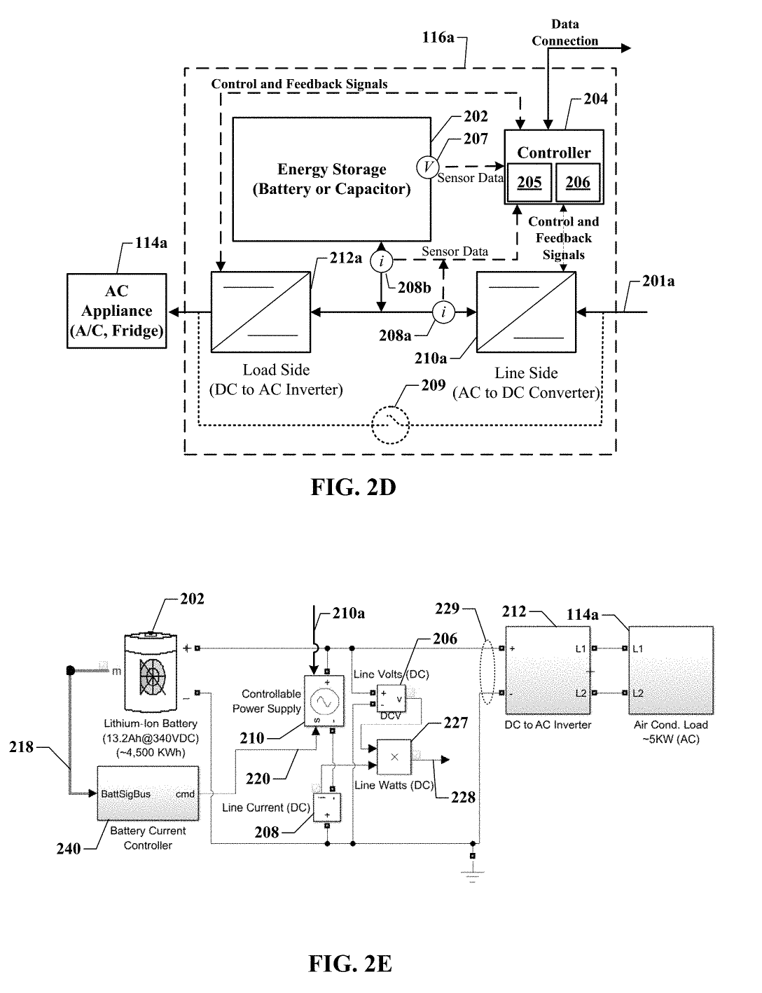

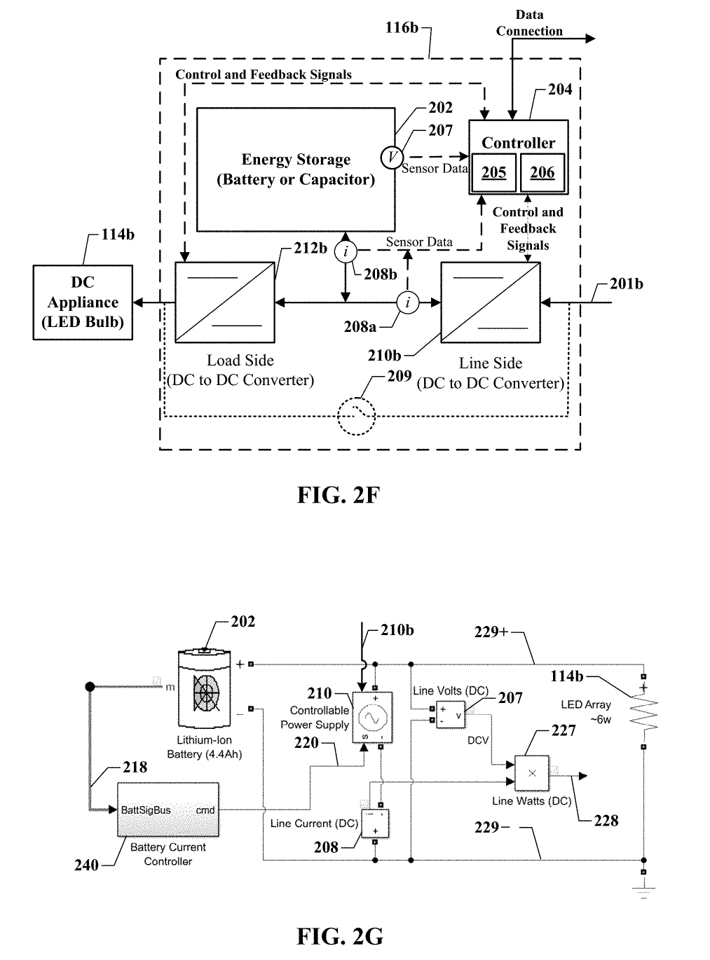

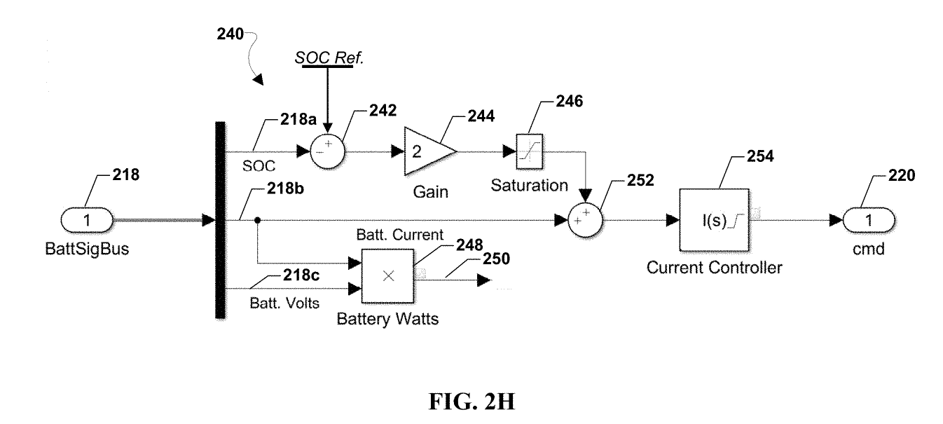

FIG. 2A is a block diagram of a system 200a providing a typical approach to DR for managing power delivered to an appliance or device. The example system 200a illustrated in FIG. 2A includes an air conditioner (A/C) unit 114 connected to a power meter 102. The system 200a may also include a controller 112 configured to enable A/C unit 114 to connect wirelessly to cloud connected apps 110. Although WiFi controller 112 is shown as a discrete component, this is only for simplicity and WiFi, or other wireless or wired connectivity capability, may be integrated into or otherwise provided by A/C unit 114.

An individual, group, or entity may control the A/C unit 114 via the WiFi controller 112 using cloud connected apps 110. For example, an occupant of a room or other space served by A/C unit 114 may launch an app on a smartphone and utilize the app to control A/C unit 114 (e.g., change the temperature, turn the unit off, turn the unit on, set a schedule, etc.). While such control may be in response to a notification of peak demand experienced by the electrical grid, the control is not automated (i.e., the user is required to initiate any change). In addition, any energy consumption from the electrical grid is binary in nature. That is, either the A/C unit 114 draws all necessary energy from the electrical grid or the A/C unit 114 is turned off and does not draw any energy from the electrical grid. Even if the A/C unit 114 included a back-up battery or other source of alternate power, the system 200a does not allow or otherwise enable the A/C unit 114 to simultaneously draw power from both the electrical grid and the back-up battery or other source of alternate power.

FIG. 2B is a block diagram of an embodiment system 200b including an energy storage and controller 116 that may enable an A/C unit 114 to simultaneously draw power from both the electrical grid and an energy store. The system 200b may also enable the A/C unit 114 to provide a DR response without interruption of service even if the energy storage is not sufficient to run the A/C unit 114 for significant amount of time. The energy storage may be a battery capable of storing power drawn from the electrical grid. The energy storage and controller 116 may include a controller configured to control the flow of power from the electrical grid via power meter 102 to the A/C unit 114 and/or the energy storage. In various embodiments, the energy storage and controller 116 may enable the A/C unit 114 to draw power from the energy storage in addition to or instead of from the electrical grid. In this way, during periods of peak demand experienced by the electrical grid, A/C unit 114 may reduce or otherwise eliminate power drawn from the grid while still functioning to provide a service to a room or other space.

FIG. 2C is a block diagram of another embodiment system 200c that may enable A/C unit 114 to simultaneously draw power from both the electrical grid and an energy store. Alternate system 200c may also enable A/C unit 114 to provide a DR without interruption of service. While system 200b may include the energy storage and controller 116 placed in parallel, the system 200c may include an energy storage and controller 116 placed in series.

FIGS. 2D-2H illustrate example configurations of the energy storage and controller 116 according to various embodiments.

FIG. 2D illustrates an embodiment of an energy storage and controller 116a configured to provide AC power to an AC appliance 114a, such as an A/C unit or refrigerator. In the example illustrated in FIG. 2D, the energy store 202 is a lithium-ion battery (e.g., a 13.2 Amp hour at 340V DC capacity battery providing approximately 4500 KWhr). In various embodiments, the energy storage and controller 116a may include an energy storage 202, which may be a rechargeable battery capable of storing electrical energy. The energy storage and controller 116a may also include a controller 204 that includes a processor 205 and memory 206. The energy storage and controller 116a may also include current sensors 208a, 208b, 208c for measuring various currents from the grid and/or the energy store 202 and to the appliance 114a, as well as voltage sensors 207 for measuring voltages across the energy store 202 and/or internal DC busses. The current and voltage sensors 207, 208a, 208b, 208c may be configured to provide sensor data to the controller 204 to support various functions of the energy storage and controller 116a. Additionally, the controller 204 may be configured to store and share such sensor data, as well as exchange control and feedback signals, with other devices (e.g., a control hub) via a communication network.

In the embodiment illustrated in FIG. 2D, the energy storage and controller 116a is configured to provide power to an AC appliance 114 a, and thus may include a line side AC to DC power converter 210a that receives AC current from a AC power source 201a (e.g., the grid), and a load side DC to AC power inverter 212a configured to provide AC power to the AC appliance 114 a. In some embodiments, the energy storage and controller 116a may include a switch 209 controlled by the controller 204 to directly connect the appliance 114a to the AC power source 201a, bypassing the current converters 210a, 212a when a DR response or charging of the energy storage 202 is not required.

In some embodiments, the controller 204 may provide control signals to and received feedback signals from the line side AC to DC power converter 210a as well as the load side DC to AC power inverter 212a. For example, the controller 204 may provide set point signals (e.g., target voltage, current and/or frequency).

Many modern appliances (e.g., refrigerators, washers, dryers, etc.) already include inverters in their direct drive systems. Thus, some embodiments involve modifying the configuration of the appliance to integrate an energy storage 202, such as a battery, along with a controller 204 and sensors 207, 208a, 208b, 208c as described above.

In some embodiments, the controller 204 may be coupled to a current sensor 208c configured to monitor power availability from the electrical grid 201a and signal the controller 204 upon detecting a power outage on the electrical grid 201a. The controller 204 may be further configured to apply power from the energy storage 202 to the AC appliance 114a via the load side DC to AC inverter 212a in response to the current sensor 208c detecting a power outage on the electrical grid. The controller 204 may be further configured to apply power from the energy storage 202 to the AC appliance periodically for short durations to extend the amount of time that the appliance can be powered by the energy storage 202. For example, integrating a battery into a refrigerator according to such embodiments would allow the refrigerator to prevent spoilage during power outages. For example, the refrigerator could operate in a “spoilage prevention” mode in which the refrigerator is either powered from a battery periodically, and/or the compressor is constrained to a low speed that keeps the power draw within the range of the battery capability to maintain cool temperatures during power outages.

FIG. 2E shows an example of components that may be implemented within the power split controller 204 in an AC power embodiment. The illustrated example of a power split controller 204 may include a controllable power supply 210 that may be configured to regulate current and voltage on an DC bus 229 output to the DC to AC inverter 212. The controllable power supply 210 may be configured to control the output voltage and current based upon or in response to input signals received from a battery current controller 240. The controllable power supply 210 may be coupled to the positive and negative power outputs of the energy store 202 and receive input power from the AC to DC converter 210a.

In the example illustrated in FIG. 2F, the energy store 202 is a lithium-ion battery (e.g., 4.4 Ah). The energy store 202 may be configured to output battery state information signals 218 indicating various conditions of the battery, including state of charge, voltage, current, etc. Batteries configured to output battery state information signals 218 are sometimes referred to as smart batteries.

The battery current controller 240 may receive the battery state information signals 218 from the energy store 202 and, based on the received battery state information, output a command signal 220 to the controllable power supply 210. This command signal 220 may enable the controllable power supply 210 to regulate the voltage and current on the DC output bus 229 to enable power splitting with power from the grid as well as meeting the power demands of the DC load 114b while operating within the limits of the power store 202.

The power split controller 204 may include a voltage sensor 206 and a line current sensor 208 configured to provide voltage and current inputs to a line watts calculator 227 that may provide a line watts output signal 228 that may be used by a processor (e.g., processor 205) to control operations of the energy storage and controller 116a.

FIG. 2F illustrates an embodiment of an energy storage and controller 116b configured for providing DC power to a DC appliance 114b, such as a light-emitting diode (LED) light bulb-. Similar to the AC power embodiment illustrated in FIG. 2D, an energy storage and controller 116b configured to provide DC power to a DC appliance 114b, such as an LED bulb 114b. In such embodiments, the energy storage and controller 116b may include an energy storage 202, such as a rechargeable battery, and a controller 204 that includes a processor 205 and memory 206. The energy storage and controller 116b may also include current sensors 208b, 208b for measuring various currents from the DC power source 201b and/or the energy store 202 and to the appliance 114b, as well as voltage sensors 207 for measuring voltages across the energy store 202 and/or internal DC busses. The current and voltage sensors 207, 208a, 208b may be configured to provide sensor data to the controller 204 to support various functions of the energy storage and controller 116b. Additionally, the controller 204 may be configured to store and share such sensor data, as well as exchange control and feedback signals, with other devices (e.g., a control hub) via a communication network.

In the DC power embodiment illustrated in FIG. 2F, the energy storage 202 and controller 116b may include a load side DC to DC converter 212b. The DC power embodiment illustrated in FIG. 2F may be suitable for implementing in a DC powered appliance, such as an LED light or laptop computer, which may have its own AC to DC power converter (either internally or externally). In some embodiments, the energy storage and controller 116b may include a DC to DC converter 212b configured to receive current from a DC power source 201B. In some embodiments, the energy storage and controller 116b may include a switch 209 controlled by the controller 204 to directly connect the appliance 114b to the DC power source 201b, bypassing the current converters 210b, 212b when a DR response or charging of the energy storage 202 is not required. In some embodiments, the DC to DC converter 212b may be replaced with an AC to DC power converter 210a (FIG. 2D) such that the appliance's converter may be integrated into the DR controller electronics.

In some embodiments, the controller 204 may provide control signals to and received feedback signals from the line side DC to DC power converter 210b as well as the load side DC to AC power inverter 212b. For example, the controller 204 may provide set point signals (e.g., target voltage or target current).

FIG. 2G shows an example of components that may be implemented within the power split controller 204 in a DC power embodiment. Similar to the AC power embodiment illustrated in FIG. 2F, a DC power split controller 204 may include a controllable power supply 210 that may be configured to regulate current and voltage on the DC positive and negative leads 229+, 229− that output to DC current to the DC load 114b. The controllable power supply 210 may be configured to control the output voltage and current based upon or in response to input signals received from a battery current controller 240. The controllable power supply 210 may be coupled to the positive and negative power outputs of the energy store 202 and receive input power from the DC to DC converter 210b.

In the example illustrated in FIG. 2G, the energy store 202 is a lithium-ion battery (e.g., a 4.4 Amp hour capacity battery) that is configured as a smart battery to output battery state information signals 218 indicating various conditions of the battery, including state of charge, voltage, current, etc. The battery current controller 240 may receive the battery state information signals 218 from the energy store 202 and, based on the received battery state information, output a command signal 220 to the controllable power supply 210. This command signal 220 may enable the controllable power supply 210 to regulate the output DC voltage and current to enable power splitting with power from the grid or DC power supply, as well as meeting the power demands of the DC load 114b while operating within the limits of the power store 202.

The power split controller 204 may include a voltage sensor 206 and a line current sensor 208 configured to provide voltage and current inputs to a line watts calculator 227 that may provide a line watts output signal 228 that may be used by a processor (e.g., processor 205) to control operations of the energy storage and controller 116b.

FIG. 2H shows an example of components and/or software modules that may be implemented within a battery current controller 240 according to an embodiment. The battery state information signals 218 received by the battery current controller 240 from the energy store 202 may include state of charge (SOC) information 218a, battery current information 218b (i.e., the amount of current flowing out of the energy store 202), and battery volts 281c (i.e., the output voltage of the energy store 202). The SOC information 218a may be compared to an SOC set point value in a comparator or delta function 242, which may provide an SOC error output. The SOC set point may be sourced from a processor or another controller. The comparator or delta function 242 may be implemented in a simple switch, from 90% to 10%, or controlled using more sophisticated methods.

The SOC error output pf the comparator or delta function 242 may be amplified by a gain or multiplier 244 (e.g., a proportional gain or Kp) before being passed to a saturation or limiter 246 that is configured to set hard limits on how much current can be off set (added or subtracted) to the current controller 254. The output of the saturation or limiter 246 may be added to the battery current 218b in a function 252 to provide either a positive or negative value that is passed to the current controller 254.

The current controller 254 integrates on the input multiplied by an internal gain (Ki). If the input is positive, then the output of the current controller 254 will integrate up, if the input is negative, then the current controller 254 will integrate down. The farther away from zero the input, the faster the output of the current controller 254 moves. The integration speed may depend on the value of the integration gain (Ki). The output 220 of the current controller 254 provides the voltage set point reference for the controllable power supply 210.

Additionally, the battery current controller 240 may a battery wattage calculator 248 that uses the battery current 218b and battery voltage 218c to calculate the watts produced by the battery. This information 250 may be provided to a processor or controller for use in managing operations of the energy storage and controller 116b.

In some embodiments, the output of the battery current controller 240 may be a reference voltage (V_{ref}) and the functioning of the battery current controller 240 may be modeled by the following formula:

V_{ref}=∫_{V}_{ₘᵢₙ}^{V}^{ₘₐₓ}Kᵢ·I_{batt}+(min_{I}_{ₘₐₓ}(max_{I}_{ₘᵢₙ}(Kₚ·(SOC_{ref}−SOC_{batt}))))) Eq. 1

In this formula (Eq. 1), Vₘₐₓ is a maximum reference voltage, Vₘᵢₙ is a minimum reference voltage, Kᵢ is an integral gain, I_{batt} is the battery current, Iₘₐₓ is the maximum offset current, Iₘᵢₙ is the minimum offset current, Kₚ is a proportional gain, SOC_{ref} is the reference state-of-charge of the battery, and SOC_{batt} is the state-of-charge of the battery.

In various embodiments, power splitting may occur naturally when the output of the controlled AC to DC power supply becomes lower than the battery. The battery current controller 240 simply adjusts the voltage reference 220 to the AC to DC power supply, which is the controllable power supply 210 in the AC power embodiments. The load (e.g., 114a) will draw its required power and the result will be that the battery will start to discharge because the DC bus has a lower voltage than the battery. Power splitting may be controlled by a controller 204 by changing the SOC reference to cause an error output from the comparator 252. This error will cause the current controller 254 (e.g., an AC to DC power supply) to increase (e.g., to charge the energy store 202) or decrease (e.g., to discharge the energy store 202) depending on the sign of the error. The SOC reference may be stepped to a new setting or ramped using another controller or source.

In various embodiments, the processor 205 of the controller 204 may be configured with processor-executable instructions to control power drawn from the electrical grid by sending control signals to various switches and power converter circuits. The processor 205 may be configured to perform such operations in response to commands received by a communication network, such as a residence or business communication network. As described above, such commands may originate from a control hub 120, 122 within the residence or business that is configured to communicate with the utility 124 and with any local communication network 122 within the residence or business.

The processor 205 may be configured by a user to respond to DR events in a particular manner, with the user configurations stored in the memory 206. A user may configure the processor 205 to respond to DR events by adjusting the grid/battery sharing ratio using a variety of programming interfaces, such as via a user interface on the energy storage and controller 116a, a user interface as part of the communication network 122, a user interface provided by the control hub 120, and/or an app executing on another computing device 130, 132. For example, the user may configure the processor 205 of an LED bulb that includes a battery to respond to a DR event by running in battery power if the light is on and the event occurs after dark. Using an app executing on a computing device (e.g., a smartphone), the processor 205 may be configured to adjust the grid/battery power splitting ratio and set other details for responding to a DR event at any time, including at the time of sale by a sales technician. Thus, the various embodiments free consumers from having to manually configure appliances during DR events.

The processor 205 may be connected to various sensors (e.g., current and voltage sensors) to receive sensor data regarding various electrical parameters and characteristics (e.g., power flowing to the appliance 114a, 114b). The processor may communicate such sensor data, or information obtained by analyzing such data, to another computing device via a data connection 240. The processor 205 may also receive commands for configuring responses to DR events, as well as messages from a utility 224 initiating DR events and providing other information (e.g., current electricity rates) via the data connection 240. As described with reference to FIG. 1, the data connection 240 may be via a Wi-Fi to a local wireless communication network 122.

The processor 205 may also be configured to control the line side converter 210 and load side converter 212, 212b (e.g., by opening and closing switches that are not shown) in order to control power flowing to the appliance 114a, 114b and/or the energy storage 202. With such control capabilities, the processor 202 can control the charging of the energy store 202, such as when electricity rates are low, and discharging of the energy stored 202 to power the appliance 114a, 114b during a DR event.

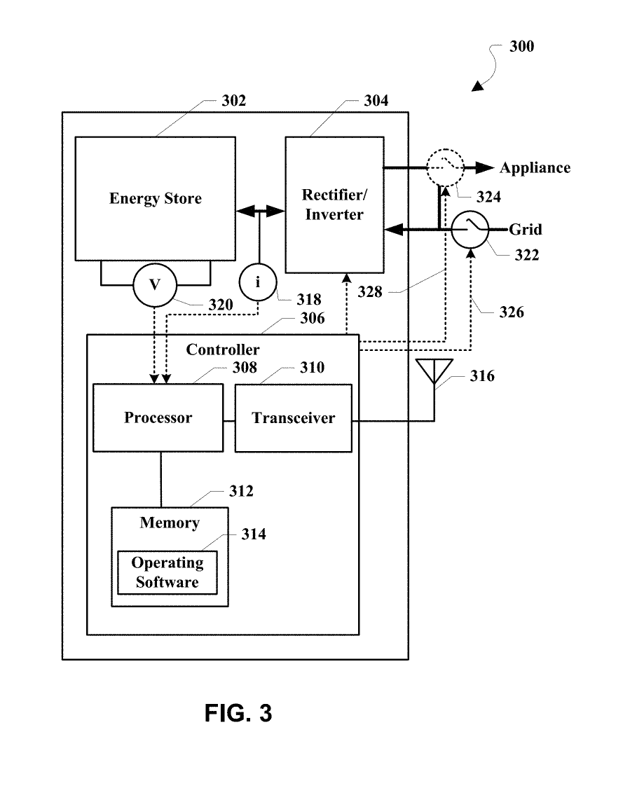

For example, during periods of non-peak demand experienced by the electrical grid, the utility may transmit messages to a control hub within the residence or business indicating a lower price for power is in effect. In response to such messages, the control hub may transmit messages to individual appliances and devices indicating that power from the grid should be used to recharge batteries if the state-of-charge of the batteries is less than fully charged. In response to such signals, the processor 205 of the controller 204 may be configured to actuate various switches (e.g., illustrated in FIG. 3) and control power converters 210, 212a, 212b so as to draw power from the electrical grid and feed power to the energy storage 202 for recharging and to AC appliance 114a if the appliance is currently on.

As a further example, during periods of peak demand experienced by the electrical grid, the utility may transmit messages (e.g., via the cloud 110) to a control hub 120 within the residence or business indicating that a DR event is in effect. In response to such messages, the control hub 120 may transmit messages to individual appliances 114a, 114b and devices indicating that power from the grid should be reduced by splitting power between the energy storage 202 and the grid, or disconnecting the appliance from grid power and using power from the battery if the appliance is on. In response to such signals, the processor 205 of the controller 204 within or connected to each appliance may actuate various switches and control power converters 210, 212a, 212b so as to reduce or eliminate power drawn from the electrical grid, drawing power from the energy store 202 if the appliance is on.

Although FIGS. 2A-2F show a single the energy storage and controller 116 connected to a single appliance or other device 114, this is only for simplicity. In various embodiments, a single the energy storage and controller 116 may be configured to provide power to multiple appliances or other devices. Although FIGS. 2A-2F show the energy storage and controller 116 as an external or otherwise discrete component, this is only for simplicity. In various embodiments, the energy storage and controller 116 may be integrated within and/or otherwise closely coupled to a device or appliance 114. In addition, while the energy storage and controller 116 is shown as drawing power from an electrical grid, this is only for simplicity. In various embodiments, the energy storage and controller 116 may draw power from other sources, such as a local grid, generator or power supply, and the energy storage and controller 116 may also deliver power back to the electrical grid or a local power supply.

FIG. 3 is a block diagram of a DR control device 300 that may be coupled to standard appliances instead of implementing the energy storage and control components within the appliance. A DR control device 300 may include a larger energy store 302 than could be integrated within an appliance, thereby enabling the appliance to run longer on battery power during DR events. Further, DR control device 300 may support multiple appliances, which may be individually controlled during DR events.

In various embodiments, the DR control device 300 may include an energy store 302 and a rectifier/inverter 304. The rectifier/inverter 304 may be configured to rectify AC power drawn from the electrical grid and provide the DC current to the energy store 302 for charging, and invert stored DC power from the energy store 302 for delivering AC power to one or more connected appliances. The rectifier/inverter 304 may also be configured to draw power from an electrical grid, condition the power, and deliver conditioned power to an appliance or other device. The energy store 302 may be a battery, a capacitor, or other element configured to store energy.

In various embodiments, the DR control device 300 may include a controller 306. The controller 306 may include a processor 308, and a transceiver 310 (e.g., a Bluetooth® or Wi-Fi transceiver) coupled to an antenna 316 configured to communicate with a wireless communication network (e.g., 122). The controller 306 may also include memory 312 in which operating software 314 may be stored. The memory 312 may be coupled to the processor 309 and include volatile and/or non-volatile storage including, but not limited to, hard disk, flash, read-only memory (ROM), random access memory (RAM), and/or other such storage. The operating software 314 may include machine-executable instructions to configure the processor 308 to perform operations of the various embodiments.

In various embodiments, the DR control device 300 may include a current (i.e., amp) meter 318 and a volt meter 320 configured to provide measurement signals to the controller 306 and/or processor 308. The controller 306 and/or processor 308 may also be configured to provide control signals (e.g., set points, on/off signals, etc.) to the rectifier/inverter 304.

In some embodiments, the DR control device 300 may include switches 322, 324 on input and output power lines that are coupled to and configured to be actuated by the controller 306 via control lines 326, 328. The switches 322, 324 may be configured to enable the controller 306 direct current from the grid directly to the appliance or to the rectifier/inverter 304. The switches 322, 324 may be configured to enable the controller 306 to isolate the DR control device 300 and/or the appliance from the grid. The switches 322, 324 may also be configured to enable the controller 306 to provide power from the rectifier/inverter 304 to the grid.

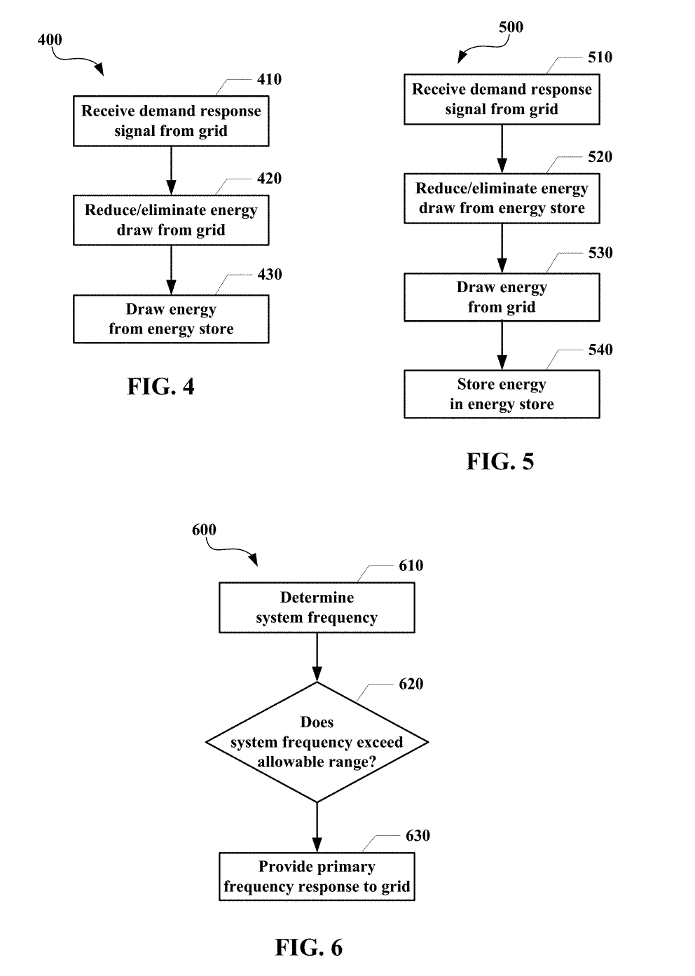

FIG. 4 is a process flow diagram of a method 400 for controlling power by a DR control device 116, 300. The method 400 may be implemented in a processor (e.g., 205, 308) of a controller (e.g., 204, 306).

In block 410, the processor may receive a DR event signal from a utility via a network, such as the cloud 110 or a direct communication link. For example, the DR event signal may indicate a period of peak demand being experienced by the electrical grid and that power demand should be reduced.

In block 420, the processor may reduce or otherwise eliminate energy drawn from the electrical grid, such as by disconnecting grid power from one or more appliances. The processor may accomplish this by actuating certain switches within the DR control device to isolate the appliance from the grid.

In block 430, the processor may actuate switches within the DR control device to draw DC power from an energy store, invert the power to AC current and supply the AC current to the one or more appliances. In this way, the reduction in power drawn from the electrical grid may be offset by drawing power from the energy store to enable the appliance to remain on. As such, the DR control device may be able to provide a DR response without service interruption by the appliance.

In a particular embodiment, in block 430, the processor may actuate switches controlling the power inverter and rectifier so that power drawn by the appliance is split between the grid and the energy store. In such an embodiment, the processor may direct power from the energy store to the appliance via the inverter an amount that meets a portion of the power demanded by the appliance, and permit the grid to make up the rest of the demanded power. This has the effect of reducing demand on the grid while extending the period of time that the appliance can operate on battery power. This capability may also enable appliances configured to respond to DR events to be equipped with a smaller battery, which may ease the challenge of integrating an energy store into the appliance. For example, in the case of an A/C unit, sharing power between the grid and the energy store they have a similar impact on the grid as increasing the setpoint temperature for the A/C unit. Thus, this mode of operation may enable a user to enjoy full air-conditioning while effectively meeting a request from the utility to increase the setting on the unit's thermostat.

FIG. 5 is a process flow diagram of a method 500 for controlling power by a DR control device, such as the energy storage and controller 116. The method 500 may be implemented in a processor (e.g., 205) of a controller (e.g., 204, 306).

In block 510, the processor may receive electric rate information from utility. For example, the electric rate information may announce a period of low cost electricity during a period of non-peak demand being experienced by the electrical grid. In some cases, the electric rate information may include financial incentives to actually draw power from the grid to charge the energy store 202 when the grid is experiencing excess capacity and insufficient demand, such as when renewable energy sources (e.g., wind and/or solar generating capacity) exceeds the current demand on the grid.

The processor may respond to such electric rate information by reducing or eliminate energy drawn from the energy store in block 520, and connecting one or more appliances to the grid in block 530.

In block 540, the processor may take advantage of favorable electricity rates and/or incentives to increase the amount of current drawn from the grid by inverting power from the grid to DC power and storing energy in the energy store. In this way, when an electrical grid is not experiencing a period of peak demand, the DR control device may draw energy from the electrical grid to recharge the energy store as well as power any appliance that are on.

FIG. 6 is a process flow diagram of a method 600 for a DR control device to support a power grid according to an embodiment. The method 600 may be implemented in a processor (e.g., 205) of a controller (e.g., 204, 306) of a DR control device (e.g., 300).

In block 610, the processor may determine a grid frequency by measuring the phase or frequency of power and turning the DR control device.

In block 620, the processor may compare the grid frequency to allowable range of frequencies to determine whether the grid frequency exceeds an allowable range. In various embodiments, the allowable range may be +/−36 mHz.

While the system frequency remains within the allowable range (i.e., determination block 620=“Yes”), the processor may continue to monitor the grid frequency in block 610.

In response to determining that the grid frequency is outside the allowable range (i.e., determination block 620=“No”), the processor may connect the inverter to the grid and draw power from the battery to supply power onto the grid at the correct frequency (e.g., 60 Hz) in block 630. By increasing (over-frequency event) or decreasing (under-frequency event) load on the grid, a DR control device can contribute to stabilizing a power grid. While a single DR control device may have little impact on the power grid, a large number of DR control devices performing the same function may help to support the grid particularly during times of transients. Such capabilities may be useful to electric utilities that include a large number of distributed renewable energy sources, such as rooftop solar arrays, small windmills, etc. Such electricity networks may experience transient frequency excursions on the grid as power generation varies (e.g., as clouds pass overhead and winds drop between gusts), particularly during times when baseload units are idled because renewable energy generation equals or exceeds current demands on the grid.

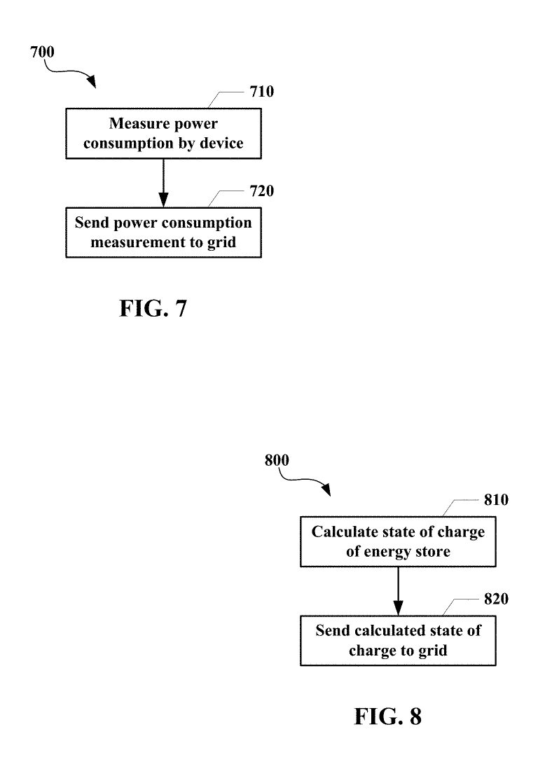

FIG. 7 is a process flow diagram of a method 700 for a DR control device to report power usage to a utility according to an embodiment. The method 700 may be implemented in a processor (e.g., 205) of a controller (e.g., 204, 306) of a DR control device (e.g., 300).

In block 710, the processor may measure current drawn by the client and/or the DR control device. For example, the processor may monitor current sensors within the DR control device over a period of time to determine peak and/or average power consumption by the DR control device (e.g., charging the energy store) and/or one or more connected appliances.

In block 720, the processor may send the power consumption measurement to an electric utility. In this way, the utility may be informed of the power consumption of the appliance or DR control device in real time. Based on the received information, including historical data previously received, the utility may make better informed decisions regarding power demands and selecting individual residences or businesses on which to impose a DR event.

FIG. 8 is a process flow diagram of a method 800 for managing an energy store of a DR control device. The method 800 may be implemented in a processor (e.g., 205) of a controller (e.g., 204, 306) of a DR control device (e.g., 300).

In block 810, the processor may measure a state of charge (SOC) of the energy store. This may be accomplished by monitoring the amount of energy drawn from the energy store (e.g., by integrating current over time) and/or voltage across the energy store. For example, the state of charge of the energy store may be calculated by subtracting the total power drawn from the energy store since the energy store was last fully charged, in which the total power drawn from the energy store may be calculated as an integral of power output over time.

In block 820, the processor may communicate the calculated state of charge information to the electric utility and/or a user computing device (e.g., via the cloud to an app executing on the user's smartphone 130). Reporting the state of charge to a consumer computing device may enable the computing device to compute and present on a user interface display a duration that the appliance can operate under a given grid/battery power splitting ratio. Such information may be useful to a consumer for configuring or adjusting the appliance for responding to DR events.

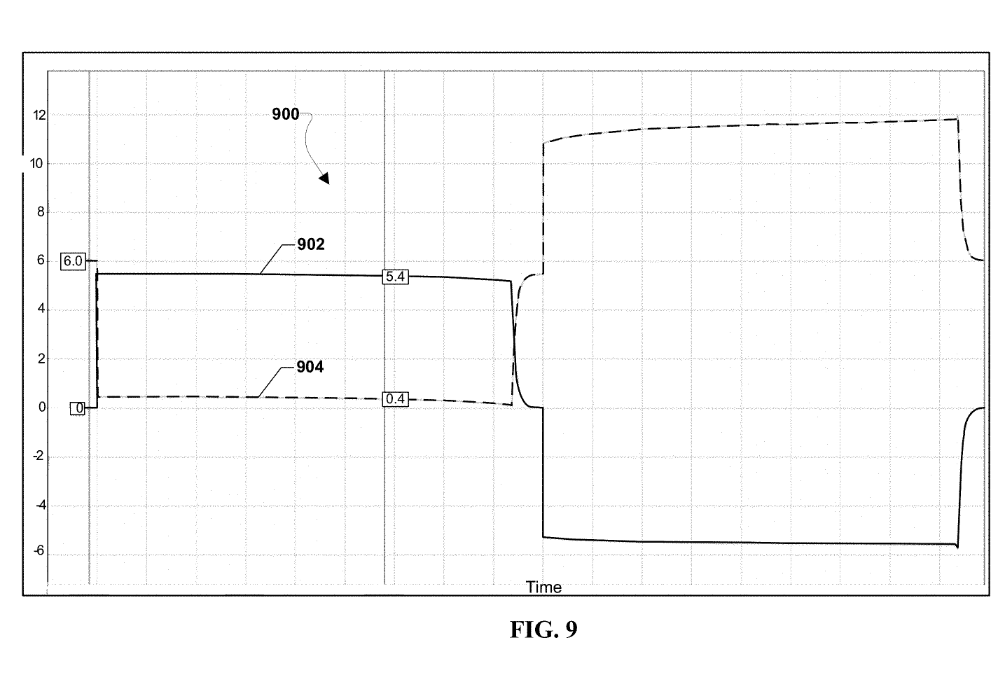

FIG. 9 illustrates voltage plots of current provided by a DC power source and the energy store in a simulation of an example of power splitting followed by recharging. As illustrated, a DC power supply 904 may initially be at 6.0 V while the energy store 902 will initially be 0.0 V. Upon initiating power splitting, the energy store 902 may begin contributing 5.4 V (for example) while the voltage drawn from the DC power supply 904 is reduced to 0.4 V (for example). When the energy store is depleted or the demand response event ends, the voltage of the DC power supply 904 may return to 6.0 V and the energy store 902 may return to 0.0 V. Thereafter, the voltage provided by the DC power supply 904 may be increased to close to 12 V to enable recharging of the energy store 902. When the energy store is recharged, the voltage of the DC power supply 904 may return to 6.0 V and the energy store 902 may return to 0.0 V.

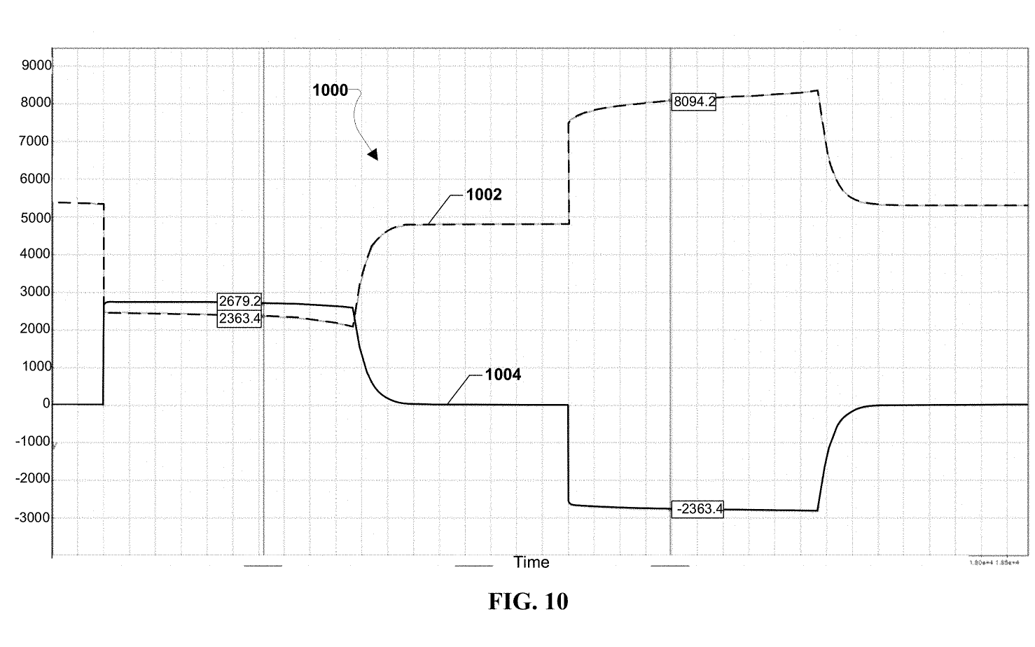

FIG. 10 illustrates power plots of current provided by an AC power source and the energy store in a simulation of an example of power splitting followed by recharging. As illustrated, an AC power supply 1004 may initially provide about 5000 watts while the energy store 1002 will initially be providing no power. Upon initiating power splitting, the energy store 1002 may begin contributing 2679.2 watts (for example) while the voltage drawn from the AC power supply 1004 is reduced to 2363.4 watts (for example). When the energy store is depleted or the demand response event ends, the power provided by the AC power supply 1004 may return to about 5000 watts and the energy store 1002 may return to providing no power. Thereafter, the power provided by the AC power supply 1004 may be increased to 8094.2 watts (for example) to meeting the load and enable recharging of the energy store 1002 that draws 2363.4 watts (for example). When the energy store is recharged, the power supplied by the AC power supply 1004 may return to about 5000 watts and the energy store 1002 may return to providing no power and drawing no power.

The various embodiments illustrated and described are provided merely as examples to illustrate various features of the claims. However, features shown and described with respect to any given embodiment are not necessarily limited to the associated embodiment and may be used or combined with other embodiments that are shown and described.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor (e.g., 308) may be any conventional processor, controller, microcontroller, or state machine, such as a microprocessor, multi-core processor, system-on-chip, and the like. For example, a processor may be implemented as a combination of receiver smart objects, such as a combination of a DSP and a microprocessor, two or more microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method for controlling energy usage of an appliance with an integral internal energy store by a processor within a control device, comprising:
receiving a demand response signal from a utility;
in response to receiving the demand response signal:
controlling the appliance to reduce power drawn from the electrical grid; and
providing power to the appliance from an integrated internal energy store such that the appliance is partially powered by the electrical grid and partially powered by the integrated internal energy store;
determining a grid frequency; and
supplying power onto the electrical grid at a correct frequency by drawing power from the integrated internal energy store in response to determining that the grid frequency is exhibiting an under-frequency event.

2. The method of claim 1, further comprising:
receiving electricity rate information from the utility;
determining whether electricity rates are favorable; and
in response to determining that electricity rates are favorable:
connecting the appliance to the grid if not already connected; and
drawing power from the grid to recharge the integrated internal energy store.

3. The method of claim 1, further comprising:
drawing power from the electrical grid to recharge the integrated internal energy store or increase power provided to the appliance in response to determining that the grid frequency is exhibiting an over-frequency event.

4. The method of claim 1, further comprising:
measuring an amount of grid-supplied power consumed by the appliance and the control device; and
sending the measured amount of power consumption to the utility.

5. The method of claim 1, further comprising:
calculating a state of charge of the energy store; and
sending the calculated state of charge to another computing device.

6. The method of claim 5, wherein calculating a state of charge of the energy store comprises calculating the state of charge of the energy store based on total power drawn from the energy store since the energy store last had a full state of charge, wherein the total power drawn is an integral of power output over time.

7. The method of claim 1, further comprising configuring the processor in response to a user input to adjust an amount of power drawn from the electrical grid and an amount of power drawn from the integrated internal energy store.

8. The method of claim 1, where in providing power to the appliance from an integrated internal energy store such that the appliance is partially powered by the electrical grid and partially powered by the integrated internal energy store comprises splitting power supplied to the appliance between the grid and an energy store such that the appliance is partially powered by the electrical grid and partially powered by the integrated internal energy store.

9. A device, comprising:
an energy store;
a rectifier coupled to the energy store and configured to be connected to an electrical grid;
an inverter coupled to the energy store and configured to be connected to an appliance;
a processor configured to control connections of the rectifier to the grid and connections of the inverter to the energy store, wherein the processor is configured with processor-executable instructions to perform operations comprising:
receiving a demand response signal from a utility;
in response to receiving the demand response signal:
controlling the appliance to reduce power drawn from the electrical grid; and
providing power to the appliance from the energy store such that the appliance is partially powered by the electrical grid and partially powered by the energy store;
determining a grid frequency; and
supplying power onto the electrical grid at a correct frequency by drawing power from the energy store in response to determining that the grid frequency is exhibiting an under-frequency event.

10. The device of claim 9, wherein the processor is configured with processor-executable instructions to perform operations further comprising:
receiving electricity rate information from the utility;
determining whether electricity rates are favorable; and
in response to determining that electricity rates are favorable:
connecting the appliance to the grid if not already connected; and
drawing power from the grid to recharge the energy store such that the appliance is partially powered by the electrical grid and partially powered by the energy store.

11. The device of claim 9, wherein the processor is configured with processor-executable instructions to perform operations further comprising:
drawing power from the electrical grid to recharge the energy store or increase power provided to the appliance in response to determining that the grid frequency is exhibiting an over-frequency event.

12. The device of claim 9, wherein the processor is configured with processor-executable instructions to perform operations further comprising:
measuring an amount of grid-supplied power consumed by the appliance and the device; and
sending the measured amount of power consumption to the utility.

13. The device of claim 9, wherein the processor is configured with processor-executable instructions to perform operations further comprising:
calculating a state of charge of the energy store; and
sending the calculated state of charge to another computing device.

14. The device of claim 13, wherein the processor is configured with processor-executable instructions to perform operations such that calculating a state of charge of the energy store comprises calculating the state of charge of the energy store based on total power drawn from the energy store since the energy store last had a full state of charge, wherein the total power drawn is an integral of power output over time.

15. The device of claim 9, wherein the processor is configured with processor-executable instructions to perform operations further comprising configuring the processor in response to a user input to adjust an amount of power drawn from the electrical grid and an amount of power drawn from the energy store.

16. The device of claim 9, wherein the device is a component integrated within the appliance.

17. The device of claim 9, wherein the device is separate from the appliance and the device is configured to connect to the grid and to the appliance.

18. The device of claim 9, further comprising an electrical sensor configured to detect a power outage on the electrical grid, wherein the processor is coupled to the sensor and configured with processor-executable instructions to perform operations further comprising powering the appliance from the energy store in response to the sensor detecting a power outage on the electrical grid.

19. An appliance, comprising:
an integrated internal energy store;
means for receiving a demand response signal from a utility;
means for controlling the appliance to reduce power drawn from the electrical grid in response to receiving the demand response signal;
means for providing power to the appliance from the integrated internal energy store such that the appliance is partially powered by the electrical grid and partially powered by the integrated internal energy store;
means for determining a grid frequency; and
means for supplying power onto the electrical grid at a correct frequency by drawing power from the integrated internal energy store in response to determining that the grid frequency is exhibiting an under-frequency event.

20. The appliance of claim 19, further comprising:
means for receiving electricity rate information from the utility;
means for determining whether electricity rates are favorable; and
means for connecting the appliance to the grid if not already connected in response to determining that electricity rates are favorable; and
means for drawing power from the grid to recharge the integrated internal energy store.

21. The appliance of claim 19, further comprising:
means for drawing power from the electrical grid to recharge the integrated internal energy store or increase power provided to the appliance in response to determining that the grid frequency is exhibiting an over-frequency event.

22. The appliance of claim 19, further comprising:
means for measuring an amount of grid-supplied power consumed by the appliance and the control device; and
means for sending the measured amount of power consumption to the utility.

23. The appliance of claim 19, further comprising:
means for calculating a state of charge of the energy store; and
means for sending the calculated state of charge to another computing device.

24. The appliance of claim 23, wherein means for calculating a state of charge of the energy store comprises means for calculating the state of charge of the energy store based on total power drawn from the energy store since the energy store last had a full state of charge, wherein the total power drawn is an integral of power output over time.

25. The appliance of claim 19, further comprising means for configuring the processor in response to a user input to adjust an amount of power drawn from the electrical grid and an amount of power drawn from the integrated internal energy store.

26. The appliance of claim 19, wherein means for providing power to the appliance from an integrated internal energy store such that the appliance is partially powered by the electrical grid and partially powered by the integrated internal energy store comprises means for splitting power supplied to the appliance between the grid and an energy store such that the appliance is partially powered by the electrical grid and partially powered by the integrated internal energy store.

27. The appliance of claim 19, further comprising:
means for detecting a power outage on the electrical grid; and
means for powering the appliance from the energy store in response to a power outage on the electrical grid.
